(19) United States
(12) Patent Application Publication
(10) Pub. No.: US 2002/0033220 A1
(43) Pub. Date: Mar. 21, 2002

(54) Air no air elastomeric tire

(76) Inventor: Richard A. Steinke, Boulder City, NV (US)

Correspondence Address: M. Reid Russell, 1240 East 100 South, #10, St. George, UT, 84790, US

(21) Appl. No.: 09/943,814

(22) Filed: Sep. 4, 2001

Related U.S. Application Data
(63) Continuation-in-part of application No. 09/665,604, filed on Sep. 20, 2000.

(51) Int. Cl. B60C 5/00

(52) U.S. Cl. 152/548; 152/450

(57) ABSTRACT

An elastomeric tire for mounting onto a rim that is manufactured by casting or molding methods to include an interior arch shaped cavity that is centered under the tire tread to have at least one hundred forty (140) degrees and not more than one hundred eighty (180) degrees of arc, and with the cavity arch duplicated around the tire exterior, below the tire tread. A uniform tire wall thickness is provided that is selected for a particular anticipated load as the tire will carry, the tire supporting the load in compression, and provides ride and wear characteristics are comparable to an appropriately pressurized pneumatic tire carrying a like load, and which tire of the invention interior arch shaped cavity can be pressurized to add to its inherent load supporting character to safely support even greater loads.

### BACKGROUND OF INVENTION

This application is a continuation-in-part application of application Serial No.09/665,604 for an “AIR NO AIR ELASTOMERIC TIRE” filed Sep. 20, 2000 that is abandoned with the entry of this CIP application.

1. Field of The Invention

This invention pertains to non-pneumatic tires for mounting onto a rim as a component of a wheel and particularly to a tire that is formed, preferably by molding methods, from an elastomeric material having a center cavity that can be aired to a desired pressure, but even when the cavity is at ambient pressure, will support a design load.

2. Prior Art

The present invention contemplates a new and improved tire that, while simple in design, is revolutionary in its concept, constituting a major improvement in the tire industry. The tire of the invention will exhibit the ride and wear characteristics of, or are better than that of, a conventional pneumatic tire, that is intended for a like use to the tire of the invention. Which tire of the invention has, by its construction and wall thickness selection, an inherent load bearing capability that is essentially equivalent to the load bearing capability of a like size of pneumatic pressure. So arranged, without air, the tire of the invention will still provide load bearing support to a vehicle on which it is mounted. Further, the tire can additionally be aired to a desired greater pressure, for supporting a higher or greater load.

Elastomeric solid, cavity free, non-pneumatic tires have been used for many years going back to as early as 1878, as set out in a British Patent No. 2,367, that shows a solid rubber tire and rim. Even where such rubber tires have been formed to include inner cavities such as U.S. Pat. Nos. 450,816 and 464,767, such have not considered the relationship between the wall thickness that is uniform between the inner wall and outer wall under the tread, as does the invention, for different loads. With some edges of the wheels of the 464,767 patent are shown as formed at greater than one hundred eighty degrees of arch, as called for in the invention. Solid rubber tires having cavities are also shown in U.S. Pat. No. 612,583, but which cavities are circles or modified circles and the does not include a relationship in any of the embodiments where the cavity is supported by rim edges at ends of one hundred eighty degrees or arc or less, as called for by the invention. Further, a U.S. Pat. No. 1,014,318 shows, in FIG. 1, an arch shaped cavity maintained between hook ends of a rim, but the patent is directed to rim configurations only and there is no discussion of a relationship between load bear capabilities as relates of wall thickness between the inner and outer arch surfaces. Finally, while cavities are shown in the wheels of U. S. Pat. Nos. 3,948,303 and 5,524,913, these patents are directed to tire mountings to a rim and there is no discussion of loading bear capabilities of the tire and wheel arrangements, as shown. Only the present invention recognizes the load bearing capabilities of an elastomeric tire have a centered arch shaped cavity of no greater than one hundred eighty degrees of arc between rim support ends and relates load bearing capability of a tire with such arch shaped inner cavity at atmospheric or ambient pressure to wall thickness between the arch shaped cavity surface and the tire outer surface, below the tread.

A number of later patents that also show non-pneumatic tire and tire and rim combinations include, for example, British Pat. Nos. 3,432; 15,439; 20,186; and 27,224, French Pat. Nos. 338,920 and 367,981 and U.S. Pat. Nos. 1,056,976; 1,178,887; 3,533,662 and 5,229,047, but do not show an arch shaped inner cavity. Further, non-pneumatic tires that do not include a center cavity are shown in earlier U.S. Pat. Nos. 4,855,096; 4,943,323, 5,906,836 and 6,165,397 that were co-invented by the present inventor. Additionally, other earlier patents covering non-pneumatic tires that include inner cavities that are not arch shaped, are shown in early British Patent Nos. 11,800 and 14,997; along with early U.S. Pat. Nos. 1,194,177 and 1,670,721. Such cavities, however, are set out as for allowing compressions of the tire side walls and bead sections so as to allow the tire to be fitted into a rim, and for cushioning. None of which solid non-pneumatic tires, have included an arch shaped cavity having a load bearing capability as governed by wall thickness like that of the invention.

It is, of course, well known that non-pneumatic tires, such as those shown in some of the above cited prior art patents, have the advantage of not going flat. Heretofore, however, this advantage has not outweighed the better cushioning and shock absorbing characteristics presented by a pneumatic tire as well as the fact that solid tires, whether formed from rubber, urethane, or the like, tend to build up heat through hysteresis flexure when supporting a significant load. Pneumatic tires generally have less mass than a comparable non-pneumatic tire and, with their internal cavity tending to dissipate heat. The tire of the invention is preferably molded to include a central cavity that, dependent upon the rim configuration, can be air retaining and, accordingly, like the pneumatic tire with its open interior, will not experience a damaging heat build-up under a significant load.

Unique to the invention, its interior cavity is formed as a load bearing arch of at least one hundred forty (140) and no more than one hundred eight (180) degrees or arc to provide an inherent load support strength for the wall thickness between the arch shaped cavity wall and the tire outer wall, under the tread. Thereby, the tire of the invention with the tire arch shaped cavity pressurized to atmospheric pressure only, will exhibit a load bearing capacity in relation to its wall thickness for supporting a wide range of weights. The tire of the invention will not experience a flat, and, additionally, the arch shaped tire cavity of the invention can be pressurized to more than atmospheric pressure to increase its inherent load bearing character.

The arch design of the invention transfers loads uniformly from the tread through the arch and into a rim whereto the tire is mounted. With the load as the tire will maintain when the cavity is at ambient air pressure determined by the width of the tire between the arch shaped cavity wall and the tire outer surface, under the tread. The greater the load, the thicker the wall thickness needs to be to maintain the load. With, however, to maintain a greater load, the arch shaped cavity can be aired to a greater than atmospheric pressure. Which tire of the invention can, within the scope of this disclosure, include beads for maintaining it onto a rim, and can include side wall plys and tread reinforcement with a belt or belts that can be installed in the tire during the manufacturing process.

### SUMMARY OF THE INVENTION

It is a principal object of the present invention to provide an elastomeric tire formed by molding methods to include an internal arch shaped cavity, where the cavity arch is centered under the tire tread, and provides structural support to transfer loads from the tire tread through the side walls and into the rim, supporting the tire under load, and which cavity can receive air under pressure for providing additional load supporting capability.

Another object of the present invention is to provide an elastomeric tire having a center arch shaped cavity where the distance across the center cavity the center cavity wall and the tire outer surface, under the tread, is constant providing a uniform wall thickness that is selected to support a certain load when the cavity is at atmospheric pressure, and to provide a load transfer from the tire tread into the rim wherein the arch shaped cavity is centered.

Still another object of the present invention is to provide an elastomeric tire where the arch shaped cavity is formed within the tire with a uniform arc and the side walls and top area, under the tread, are of a same thickness for a load as the tire will support when the cavity is at atmospheric pressure, and the arc of which arch shaped cavity is uniform for one hundred forty (140) to one hundred eighty (180) degrees or arc from a line across the tire between support points on opposite sides of a rim.

Still another object of the present invention is to provide an elastomeric tire that is preferably formed by molding methods in a range of sizes from, bicycle tires to high duty tires, with each tire to have an inherent strength as governed by a uniform thickness between a center arch shaped cavity surface and the tire outer surface, under the tread, for supporting a design load with the cavity at atmospheric pressure, and can, through a standard tire stem fitting, receive air passed under pressure into the arch shaped cavity, for increasing the effective tire load supporting character.

Still another object of the present invention is to provide a tire whose inherent load supporting characteristics can be enhanced by an addition of plys, a belt or belts, mounted in the tire during its manufacture and can further include the mounting of beads around the opposite tire sides, at the tire inner circumference.

Still another object of the present invention is to provide a tire, with or without plys, belts or beads where the tire includes the arch shaped interior cavity that functions as a load bearing member for a selected tire thickness between the cavity surface and the tire outer surface, below the tread, to provide a tire having an effective load bearing capability when at atmospheric pressure, functioning like a pneumatic tire pressurized to a design pressure, and which cavity can receive air under pressure to increase the tire load bearing capacity.

The present invention is in a unique elastomer tire that is formed by molding methods from natural or synthetic rubber, urethane, or the like, preferably by a spin casting process, or processes, like those set out in U.S. Pat. Nos. 4,855,096; 4,943,323; 5,906,836, and 6,165,397, that the present inventor is a joint inventor of, and improvements thereto. Manufacture the tire of the invention, as by such molding process or processes, may include a continuous bladder that is positionable in the tire mold wherearound the elastomeric material is injected, forming the arch shaped cavity centered under the tread. With, after curing, the tire is first removed from the mold, followed by a removal of the bladder from the tire. If the tire is formed so as to be closed across a web area, as for fitting in a rim, such as a bicycle rim, a center slit is made therearound to allow the bladder to be removed. If the tire is formed to be open across its web area, where the tire side walls each terminating in an end or a bead end section that are each to be supported between rim inner and outer upright walls, the bladder can be pulled directly out from inside the tire. Alternatively, the mold can be formed with an interior mandrel to cast the tire therearound. Both the bladder or the mandrel are for positioning in the center of the mold cavity to provide an arch shaped center, with the elastomeric material to flow freely therearound. Accordingly, with the bladder removed, or after the tire is pulled off from the mandrel, the molded tire will have an interior arch shape cavity centered under the tire tread. A proper tire arch shaped cavity has a uniform radius taken from a point that is a crossing of a horizontal line across the tire, proximate to the tops of a rim side walls, and a vertical line that bisects the tire. With the tire outer surface, below the tread, being equidistant from the arch shaped cavity outer surface For the tire to support a design load without air at a pressure greater than ambient present in the arch shaped cavity, the cavity surface has a uniform arc through at least one hundred forty (140) degrees and up to an arc of one hundred eighty (180) degrees as taken from aligned points across the tires sides whereat the tire is supported to a rim, and with the outer surface of the tire, below the tread, exactly following the arc of the inner cavity. The distance between the cavity inner and tire outer surfaces, or thickness, is the same as measured between, approximately, the tire junctions with the tops of the rim side walls, around the tire. Which distance, along with a selection of a preferred elastomeric chemical combination, is selected for a particular load as the tire will support, and is a greater thickness as the load increases. So arranged, the cavity arch will provide a unique load bearing structural support to the tire whereby, for a selected thickness between the cavity wall and tire surface under the tread, the tire will, with the cavity at atmospheric pressure, support a design load. Further, the tire arch shaped cavity can be aired to an appropriate pressure to further increase its load carrying capability. Additionally, to further increase the inherent load bearing capability of the un-inflated tire, such as a heavy duty cycle tire, the tire side walls across and under the tread can be reinforced by the inclusion of plys and/or one or more belts can be included under the tread. For mounting the tire onto a rim, the tire can include beads. The plys, belt or belts, and beads to be cast within the tire, to become an integral part of the tire, during casting operations..

Still other benefits and advantages of the invention will become apparent to those skilled in the art to which it pertains upon a reading and understanding of the following detailed specification.

### DESCRIPTION OF THE DRAWINGS

The invention may take physical form in certain parts and arrangement of parts, and a preferred embodiments of which will be described in detail in this specification and illustrated in the accompanying drawings which form a part hereof:

FIG. 1A is a cross section perspective view of a automotive tire of the invention as that has an internal arch shaped center cavity that is shown formed with an arc of one hundred eighty (180) degrees and is for mounting onto a rim, with the tire shown as being open across a bottom area to resemble a pneumatic tubeless tire, showing a first tread embodiment;

FIG. 1B is a view like that of FIG. 1A only showing another tread embodiment;

FIG. 2A shows an automotive tire like that of FIG. 1B under load as illustrated by arrows M;

FIG. 2B shows a tire like that shown FIG. 2A only illustrating the load with arrows N:

FIG. 2C shows a tire like those shown in FIGS. 2A and 2B, only illustrating the load with arrows O;

FIG. 2D shows a tire like those shown in FIGS. 2A, 2B and 2C, only illustrating the load with arrows P;

FIG. 2E shows a graph of tire wall thickness T1 through T4 for load, summarizing the relationships of FIGS. 2A though 2D;

FIG. 3A is a sectional view of a bicycle tire embodiment of the invention shown mounted onto a bicycle rim and showing a section of a mandrel aligned for fitting in an arch shaped inner cavity of the tire;

FIG. 3B is an enlarged end sectional view taken along the line 3B-3B of FIG. 3A showing the bicycle tire removed from the bicycle rim and as having been split across the tire rim contacting base from the rim engaging web surface into the arch shaped cavity;

FIG. 4 is a view like that of FIG. 3 showing the tire mounted onto another bicycle rim and with an air retention band shown as an inverted T fitted into the split;

FIG. 4A is an expanded sectional view of the air retention band of FIG. 4 FIG. 4B is a view like that of FIG. 4A showing a valve stem as having been installed through the rim web, tire rim contacting base, and into the arch shaped cavity;

FIGS. 5A, B, C, D and E show the footprint of the tire of the invention under load pressures applied thereto of 50; 75; 100; 125 and 150 pounds, with the arch shaped center cavity at atmospheric pressure, showing the tire tread spread at the different applied loads;

FIGS. 6A, B, C, D and E show the footprint of a pneumatic tire pressurized to thirty five (35) psi, having load pressures applied thereto of 50; 75; 100; 125 and 150 pounds;

FIGS. 7A, B, C, D and E show the footprint of a pneumatic tire pressurized to forty (40) psi, having load pressures applied thereto of 50; 75; 100; 125 and 150 pounds;

FIG. 8 shows a side elevation view of a section of the tire formed to have a centered internal arch shaped cavity that is formed with an arc of one hundred forty (140) degrees and is mounted onto a rim, with the tire shown as being formed to resemble a pneumatic tubeless tire, and is open across a bottom area to fit in a rim that includes supports to maintain the tire side wall ends inner and outer surfaces;

FIG. 9 shows a tire like that of FIGs. 1A and 1B that is mounted onto a rim, with the tire shown as including beads maintained within the tire ends wherefrom a continuous section extends between the cavity wall and the tire outer surface, functioning as tire plys and a belt; and

FIG. 10 shows a side elevation view of the rim whereon the tire of FIG. 9 is mounted.

### DETAILED DESCRIPTION

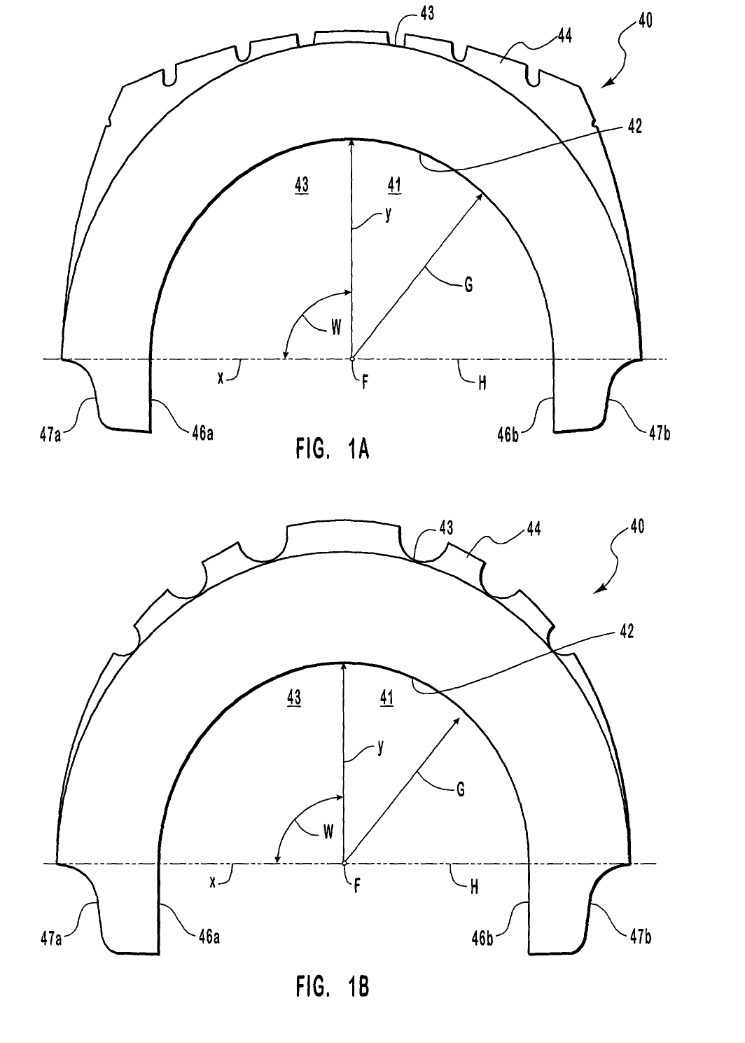

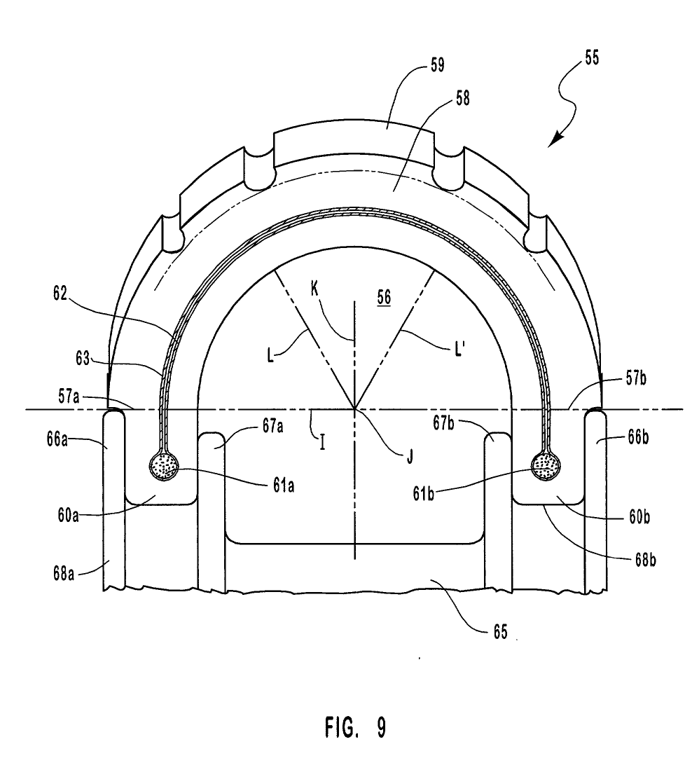

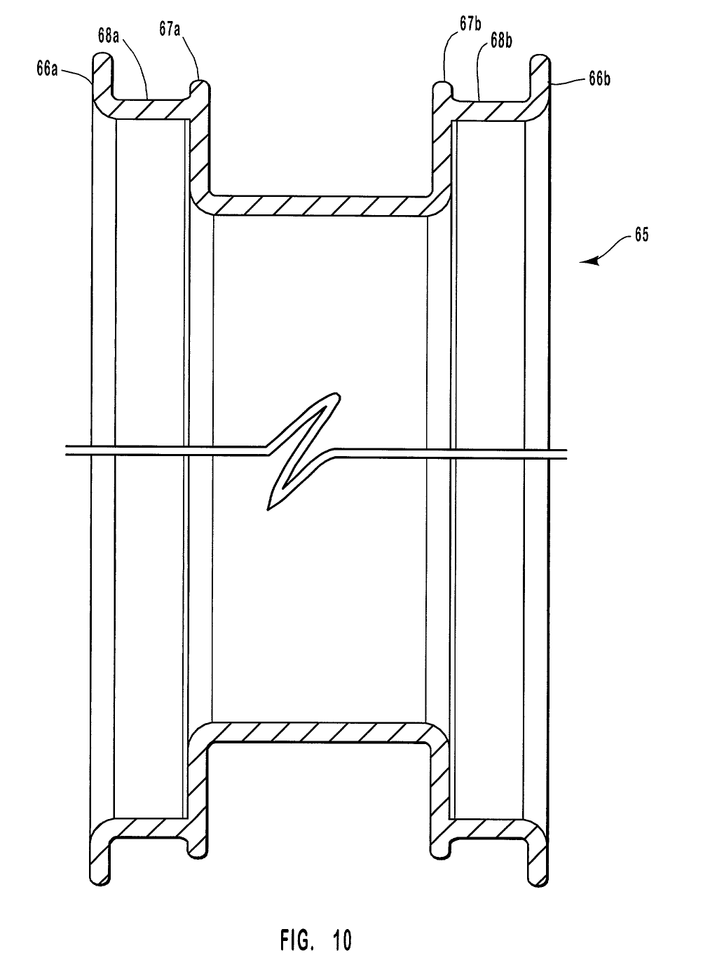

An automobile tire 40 of the invention is shown in FIGS. 1A, 1B and 8. An automobile tire 55 is shown in FIG. 9 that is the tire of FIGS. 1A, 1B and 8, that further include internal beads and a combination plys and belt, mounted within the tire and secured as its ends between the beads. Which automobile tires are discussed in detail herein below.

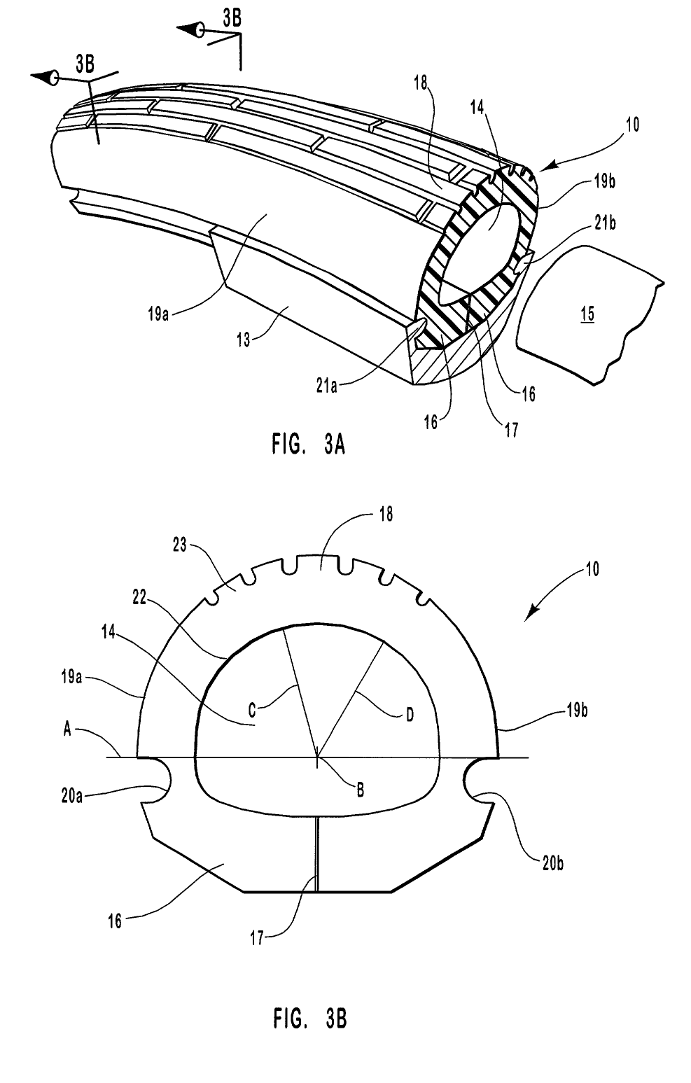

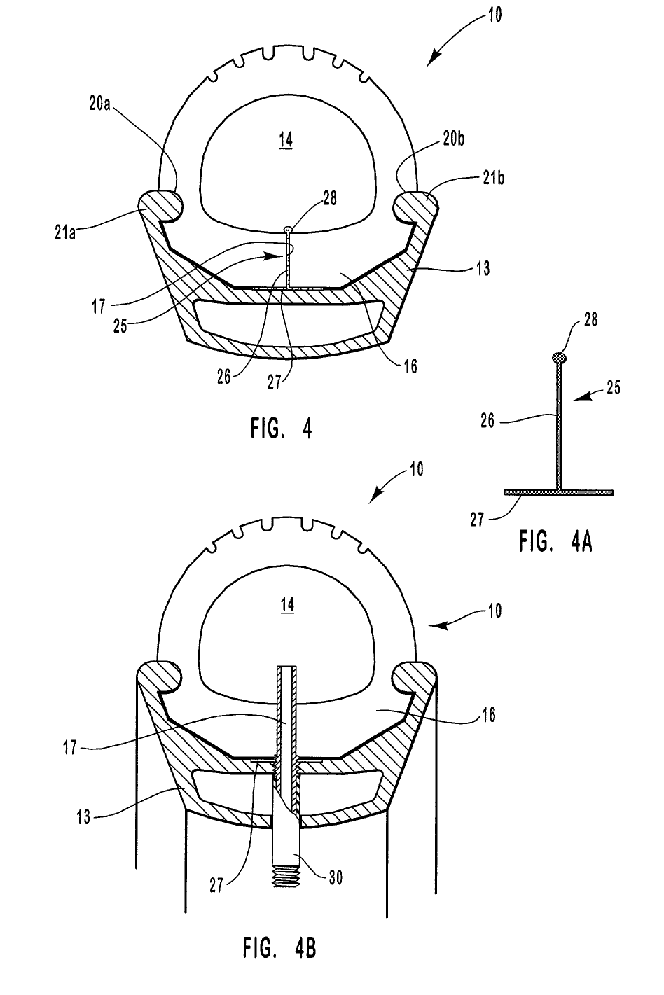

FIGS. 3A, 3B 4 and 4B show a bicycle tire 10 embodiment of the invention that is shown in FIGS. 3A, 4 and 4B mounted onto a rim 13, and is shown alone in FIG. 3B. The tire 10, as do the other embodiments of tires 40 and 55 of the invention, as described below, includes a casing or body that is preferably formed from an elastomeric material, such as a urethane material, utilizing spin casting methods like those described in apparatus and method patents, U.S. Pat. Nos. 4,855,096; 4,943,323; 5,906,836 and 6,165,397, that the present inventor is a co-inventor of. Though, it should be understood, the invention could be manufactured from other elastomeric materials, such as natural or synthetic rubber, and by other methods and apparatus from that shown in the above set out U.S. Patents, to include molding where a urethane or rubber material in a liquid form is poured into a mold, or pressure molding of a rubber material where the material is squeezed, as in a mold, into a tire shape, or a like process or procedure can be employed to form the tire or tires of the invention, within the scope of this disclosure. It should therefore be understood that the invention resides in the unique arch shaped interior cavity that provides for load bearing structural strength without air at higher than atmospheric pressure being in the interior cavity, and not in a particular manufacturing process or material used in that manufacture. The arch shaped cavity provides for the tire under load being in compression at all times, with load forces directed around the arch and into the tire mounting points to a rim, and even when side loads are exerted thereon. So arranged, the tire of the invention exhibits a load bearing ability even when the arch shaped cavity is not under pressure to support a design load for a particular thickness or distance between the tire interior cavity wall and the tire outer surface under the tread. This load bearing strength can be increased by adding air to the cavity, as through a valve stem, or the like.

Heretofore, tires formed with cavities have not utilized the arch shape as a load supporting member as related to tire thickness, as does the invention. Unique to the invention, the tire arch shaped interior cavity is a uniform curve, that is preferably a curve from zero degrees at a horizontal line X from one tire side, through an arc or one hundred forty (140) to not more than one hundred eighty (180) degrees. The line X is shown as a solid line to the tire center in FIGs, 1A and 1B, that intersect a vertical line Y in FIGS. 1A and 1B, bisecting the tire 10, with the horizontal and vertical lines X and Y meeting at point F, that is the point of origin of the radius for the arch shaped cavity and the outer tire surface, below the tread 44, as shown in FIG. 1A and tread 44a, as shown in FIG. 1B. As shown in FIGs. 1A and 1B, the arch shaped cavity wall 42 is formed with one hundred eighty (180) degrees of arc, illustrated by angle W, that is the maximum arc as the arch shaped cavity can be formed with to provide the tire with the load bearing capability to support, in compression, a design load with air at only ambient pressure within which cavity. Further, as shown in FIG. 8, and as further set out below, a tire 40 of the invention can be formed to have an arc of not less than one hundred forty (140) degrees and still provide the required load bearing strength of the tire of the invention. Accordingly, the tire 40, and the other tire embodiments, to provide a design load bearing strength, can be formed with an arc of between one hundred forty (140) to one hundred eighty (180) degrees of arc, for both the arch shaped cavity wall and the tire outer surface, under the tread. Which arc is, as shown in FIGs. 1A and 1B, centered on a vertical line Y that divides the tire at its intersection with a horizontal line X drawn between a rim wherein the tire is mounted points of contact and support with the tire sides, as discussed herein below.

The rim points of contact are as discussed with respect to the embodiments of tires 10, 40 and 55, as shown in FIGs. 1A, 1B. 3A, 3B, 4, 4B, 8 and 9, cover both bicycle and automobile tires, and, it should be understood, other tires as incorporate the arch shaped cavity with a certain wall thickness for a design load, within the scope of this disclosure.

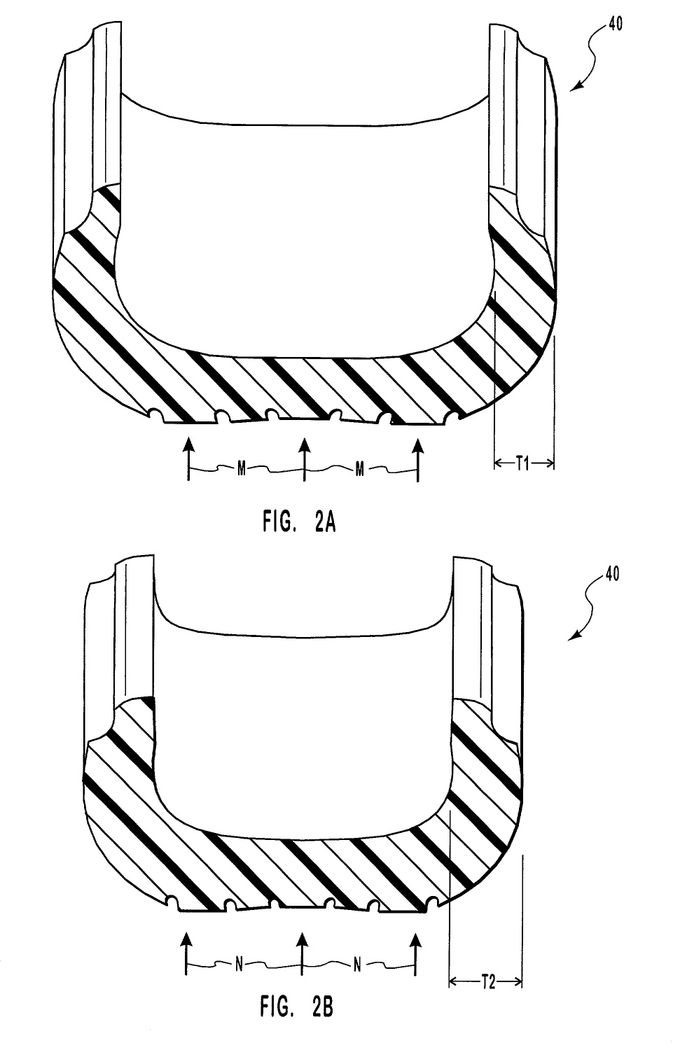

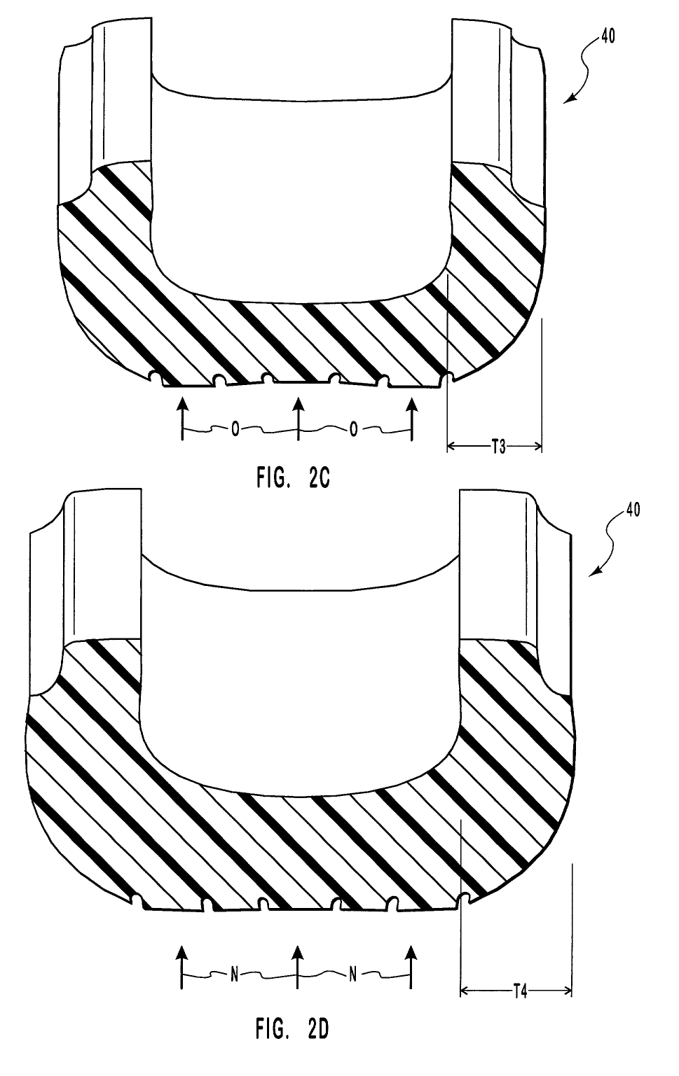

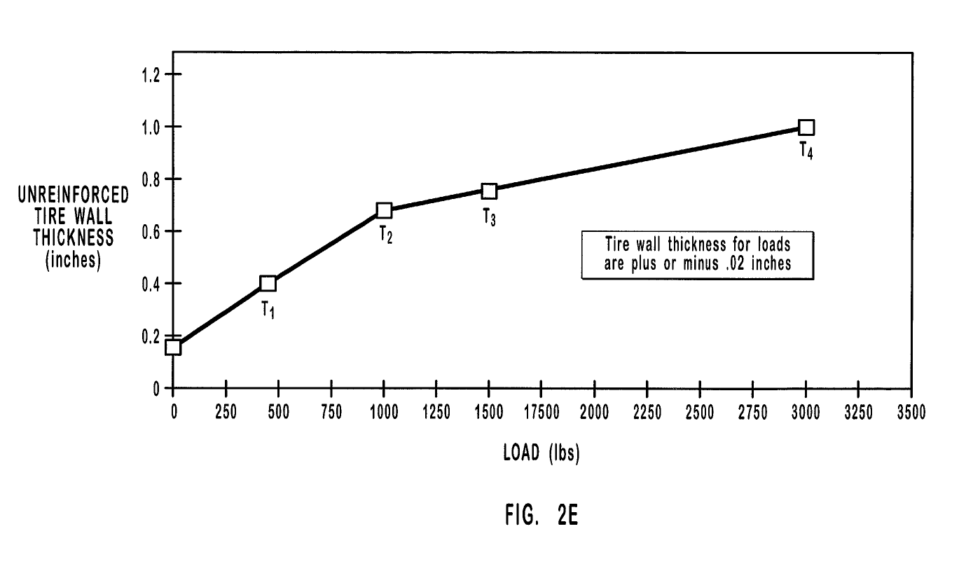

The arc for the centered arch shaped cavity, as shown in FIGS. 1A and 1B, utilizes an appropriate length of a first radius G, as the wall 42 of the arch shaped cavity 43 and a second radius H, that is scribed from the same point of origin as the first radius G to form the tire outer surface, below the tread 44, as shown in FIG. 1A and 44a in FIG. 1B. A uniform wall thickness between the tire 40 inner cavity and tire outer surface, under the tread, is thereby provided that, as shown in FIGS. 2A, 2B, 2C and 2D, is selected to provide a desired or design load bearing capacity when the inner cavity is at atmospheric pressure. Which tires 10, as well as the tires 40 and 55, have each been formed from an elastomeric material that is a combination of an isosyanate and a polyol as a chain extender that are sprayed together in the spin casing process to form the tire 10, 40 and 55. FIG. 2A shows arrows M that, per FIG. 2A and the graph of FIG. 2E, is an anticipated tire load of four hundred (400) pounds and requires, for a tire wall thickness, T1, a thickness of at least 0.40 inches, plus or minus 0.02 inches. FIG. 2B shows arrows N that, per FIG. 2B and the graph of FIG. 2E, is an anticipated tire load of one thousand (1000) pounds and requires, for a tire wall, T2, a thickness of at least 0.70 inches, plus or minus 0.02 inches. FIG. 2C shows arrows O that, per FIG. 2C and the graph of FIG. 2E, is an anticipated tire load of fifteen hundred (1500) pounds that requires a tire wall thickness, T3, of at least 0.75 inches, plus or minus 0.02 inches. FIG. 2D shows arrows P that, per FIG. 2D and the graph 2E, is an anticipated tire load of three thousand (3000) pounds that requires a tire wall thickness, T4, of at least 1.00 inch.

The graph of FIG. 2E summarizes the load to tire wall thickness relationships set out in FIGS. 2A through 2D, where each wall thickness is set out, plus or minus point zero two (0.02) inches above a four hundred (400) pound load, and shows a minimum thickness of approximately point one six (0.16) inches as an intercept with the wall thickness axis, with a straight line extending therefrom to a thickness T1 of point four (0.4) inches, for a load of four (4) hundred pounds, as shown in FIG. 2A. As shown, a straight line relationship with a uniform slope between the loads of from a minimum tire thickness to four hundred pounds, is shown in FIG. 2E. From which tire thickness T1 to T4 the slope is also approximately a straight line relationship, but is at a lesser slope. FIG. 2E thereby demonstrates that, from a minimum thickness, the tire side wall, for a tire at ambient pressure only, increases proportionally to increases in anticipated load. Which thickness increase, is at a greater slope between the intercept with the tire thickness axis and T1, and is lesser between T1 and T4, indicating that the increases as are necessary to support a design load of from approximately four hundred (400) pounds to three thousand (3000) pounds are less dramatic than the thickness changes as are needed to support a load of from zero to four hundred (400) pounds. The FIGS. 2a through 2D and the graph of FIG. 2E thereby demonstrate the direct relationship between tire wall thickness and the load that the tire can carry or support when the arch shaped cavity is at approximately atmospheric pressure.

The tire wall thickness, as discussed above, is defined as a uniform wall thickness from the tire points of engages or support points around the tire, under the tire tread, and two variations on tire treads as are appropriate for use with the tire of the invention are show in FIGS. 1A and 1B, as treads 44 and 44a. As set out above, the uniform tire wall thickness varies with load, for an arc of one hundred forty (140) degrees to not more than one hundred eighty (180) degrees, to provide the required support strength to support loads like those set out in FIGS. 2A through 2D above.

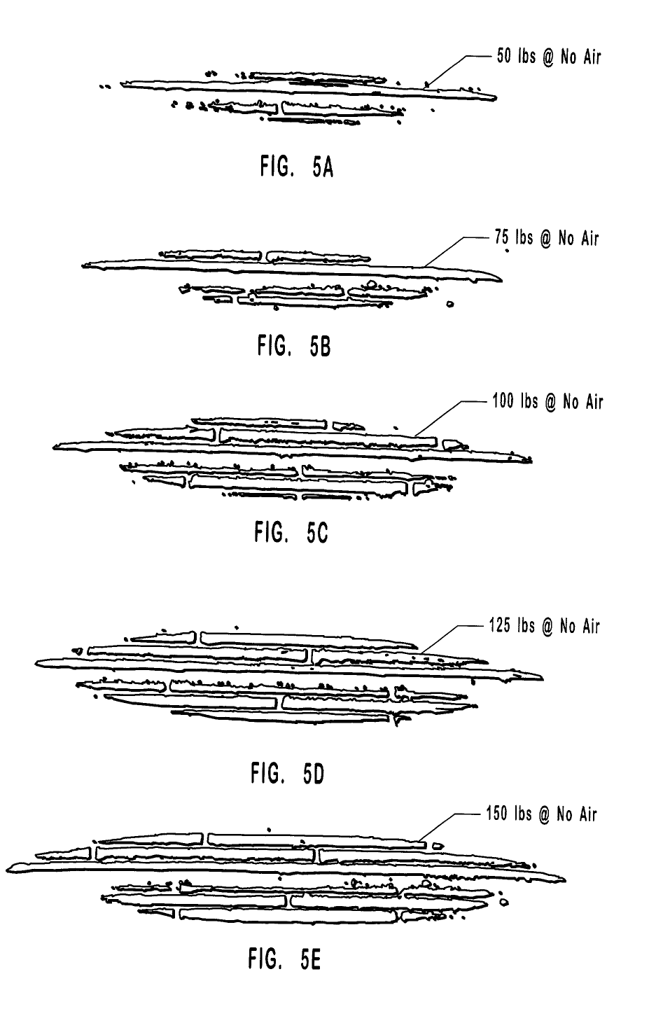

FIG. 3A shows a section of the bicycle tire 10 mounted in a section of a bicycle rim 13 that includes the arch shaped cavity 14 centered under the tread 18, within the tire 10. The tire 10, like the tires 40 and 55, is formed from an elastomeric material, preferably a urethane material, but may be natural or synthetic rubber, or the like, and each tire is preferably manufactured by spin casting apparatus and practicing of casting methods like those set out in the above cited U. S. Patents, but may be formed by molding methods by injection of a liquid elastomer into a mold, or by pressure molding methods, within the scope of this disclosure. In spin casting of the tire 10, a bladder 15, shown as a section in FIG. 3A, that may be solid or an air inflatable bladder, the tire is preferably formed from rubber to be flexible, is fitted into a cavity of a tire mold, not shown, and receives an elastomer injected therearound, in the spin casting process. After curing of the tire 10, the mold is opened and the tire containing the bladder is removed. Thereafter, a tire rim engaging section 16 formed across the tire web can then be slit at 17 as with a tool, not shown, which slit 17 is shown also in FIGS. 3B, 4 and 4B. Or such mold can include divider section to form the longitudinal slot 17 around the mold tire rim engaging web portion 16 to form the longitudinal slot 17. The tire 10 can thereby be spread apart at the slot 17, and the bladder 15 pulled therefrom. So formed, as will be discussed later herein with respect to a comparison of tire foot prints for the tire 10, as shown in FIGS. 5, 6, and 7, A through E, the arch shaped cavity provides a uniform transfer of forces from the tire tread 18 area, through the sides walls 19a and 19b that, as set out above, have a wall thickness that is selected for the anticipated tire load. Additional to force transfer that is provides by the arch shaped cavity 14 or tire 10, and the arch shaped cavities of tires 40 and 55, the arch shaped cavity provides resilient cushioning to absorb bumps and produce a ride that is comparable to that of a like design of a properly aired pneumatic tire.

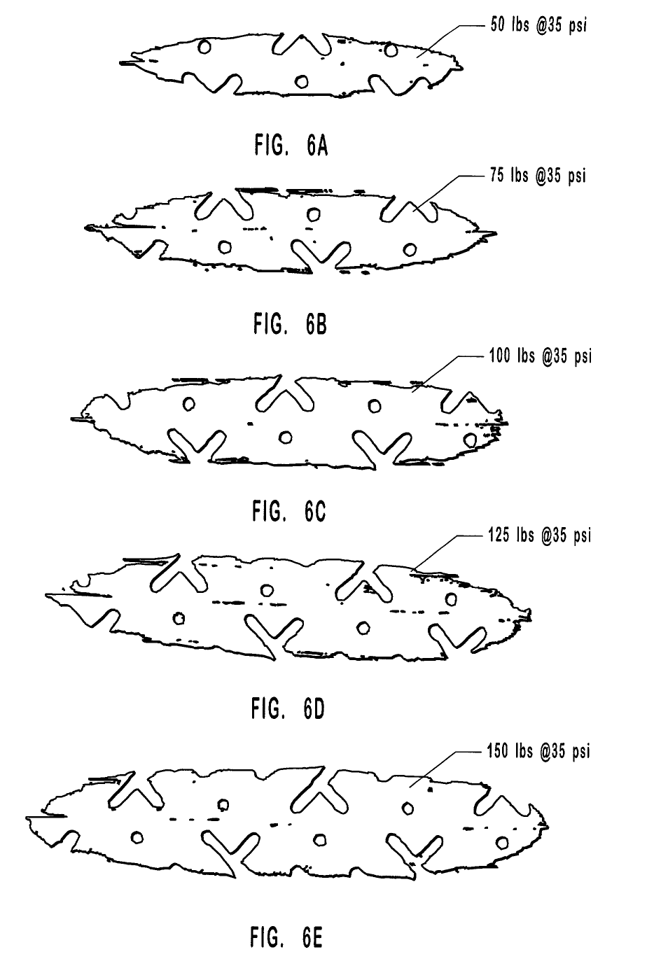

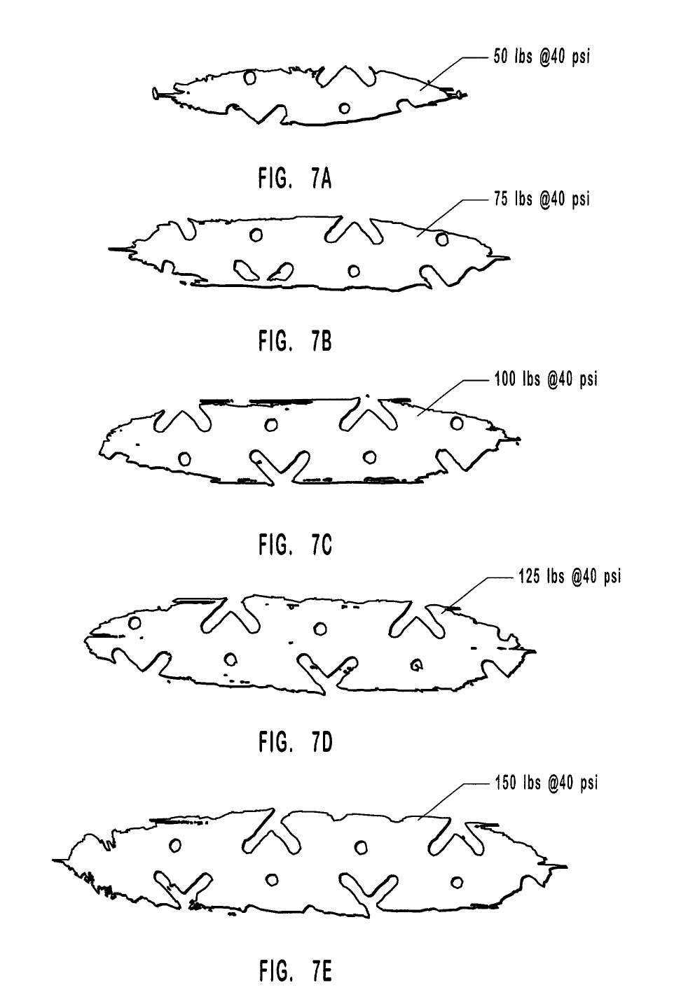

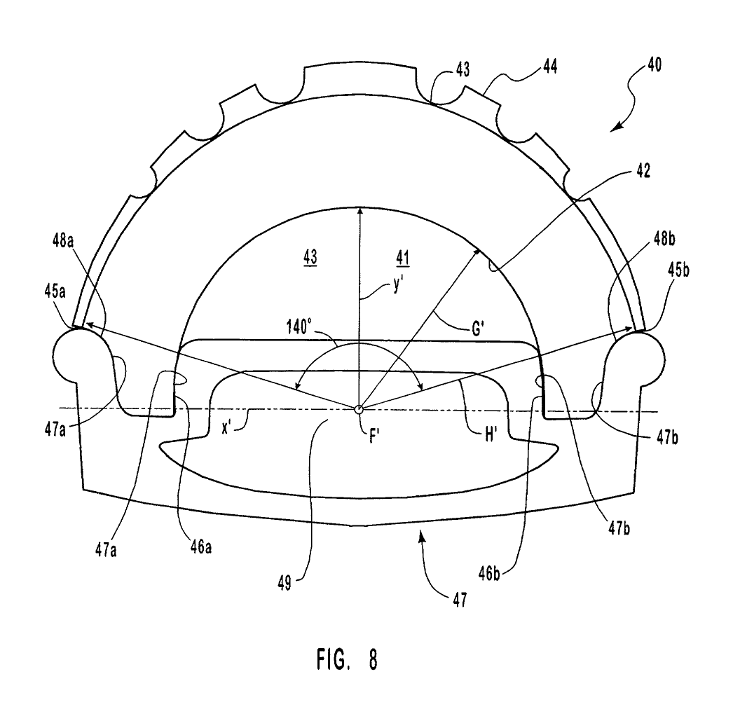

An illustration of the load bearing characteristics of the tire 10 are shown in the foot prints of FIGS. 5A-5E; 6A-6E and 7A-7E. FIGS. 5A-5E show the tire 10 containing only air at ambient pressure without air subjected to loads of 50; 75; 100; 125 and 150 pounds, respectively, and with FIGS. 6A-6E and 7A-7E, showing a like pneumatic tire that has been aired to thirty five (35) and forty (40) psi, respectively, supporting the same loads as tire 10. A comparison of the footprints clearly shows that the tire 10, without air, has load supporting abilities that are equivalent to those of a pneumatic tire pressurized from thirty five (35) to forty (40) psi. Further, tire 10 cavity 14 can be pressurized to a greater effective pressure for added load carrying capacity by pumping air into the cavity 14. In practice, while the automobile tire footprints would, of course, be wider than those of the tire 10, they exhibit like comparisons to pneumatic tires aired to thirty five (35) to forty (40) psi carrying the same loads as those shown in FIGS. 2A through 2D. With all the tire 10, 40 and 55 embodiments, and tires like those shown herein, air under pressure can be added to the tire arch shaped cavity to increase the tire's inherent load supporting strength. With, for every pound of air pressure added to the tire arch shaped cavity, the tire effective pressure is increased by that added pound of pressure.

FIG. 3A shows the tire 10 as including like shaped mounting grooves or slots 20a and 20b formed around the tire side walls above the junction of the tire side walls ends 19a and 19b. The grooves or slots 20a and 20b are each to receive a rim hook end 21a or 21b that are formed as ends of the sides of a crochet type rim 13, and with a tire rim engaging web portion 16 arranged to fit in which rim 13. For mounting the tire 10 in rim 13, the rim hook ends 21a and 21b are fitted into grooves or slots 20a and 20b that maintain the tire 10 on the rim 13.

The tire 10 is formed like the tires 40 and 55, and, as an illustration of how the arc of the arch shaped cavity is formed, FIG. 3B shows, a straight line that is drawn across the tire, just above the tops of which mounting slots 20a and 20b, identified as lateral axis A, with the junction of which lateral axis A to the center of the tire, between the side walls, illustrated as point B. Point B illustrates the location or point of origin from where a radius C is swung through one hundred eighty (180) degrees, as the cavity arch wall 22. The outer tire shape, below the tread 18, is illustrated as formed utilizing a second radius D, that, as shown, has a greater length than radius C, and is swung also from the point B, through one hundred eighty (180) degrees to form the tire outer arch, forming tire side wall 19a or 19b and a tire top portion, under the tire tread 18. The distance between the lengths of the radiuses C and D is the tire side walls and top portion thickness, below or under the tread, from the tops of the mounting slots 20a and 20b. It is this thickness that is determined for the anticipated load of the tire will carry without air other than ambient in the arch shaped cavity 14. For example, for a standard twenty six (26) inch bicycle tire that is designed to carry a load of approximately one hundred fifty (150) pounds, the tire wall and top thickness under the tread to the arch shaped cavity is approximately point one six zero (0.160) of an inch. This is a minimum thickness to provide a tire that, without air under pressure in the arch shaped cavity, will have a load carrying strength like that of a pneumatic tire pressurized to approximately thirty five (35) to forty (40) psi. As set out above, the requirement for a uniform wall and top portion tire thickness does not include the tread height that, it should be understood, does not effect the tire load supporting characteristics.

Summarizing the above, the bicycle tire 10 includes the arch shaped cavity centered under the tread and with the tire side walls and area below the tread having the same thickness. This structure provides a bicycle tire having the inherent load supporting character for a uniform wall thickness of a minimum of approximately zero point one six (0.16) inches, to provide a load bearing tire that is at least equivalent to a pneumatic tire designed to support a like load to that of bicycle tire 10 and is pressurized to a pressure between thirty five (35) and forty (40) psi. So arranged, the bicycle tire 10 can be additionally pressurized by the passage of air under pressure into the arch shaped cavity 14 to provide added load carrying capability.

FIG. 4 shows the bicycle tire 10 mounted onto rim 13, with the rim, shown as a crochet type rim, and includes tire mounting side hooks 21a and 21b that are seated in the tire grooves or slots 20a and 20b, respectively. Prior to mounting the bicycle tire 10 on rim 13, for closing the arch shaped cavity 14 so as to allow it to hold air under pressure, a continuous sealing band 25, shown as an inverted T is provided, that is shown as having been removed in FIG. 4A. The continuous sealing band 15 is formed as a continuous ring from a flexible material, such as rubber, to fit in the tire slot 17. The continuous band 25, formed as an inverted T, has a straight section 26 that connects, at one end, and at a right angle, to the center of a crossing section 27, and includes a ball 28 formed on the opposite straight section 26 end. Prior to installation of the tire 10 onto the rim 13 the continuous band sealing 25 ball end 28 and straight section 26 are fitted through the tire slot 17 to where the surface of the center crossing section 27 contacts the tire web portion 16, at the slot edges, providing, when the tire 10 is installed in the rim 13 as shown in FIG.4, an air tight seal. To pass air under pressure into the tire arch shaped cavity 14, a standard valve stem 30, shown in FIG. 4B, is installed through the rim 13 and the continuous sealing band 25 center crossing section 27, into the arch shaped cavity 14. So arranged, air is passed under pressure through the threaded end 31 of the stem 30 and into the cavity, with the pressure of such injected air adding to the tire inherent pressure whereby, for example, with the cavity pressurized to fifteen (15) psi, the tire 10 will have an inherent strength or structural pressure equivalent of approximately forty (40) psi, and will exhibit a load bearing capability and ride like that of a pneumatic tire pressurized to approximately fifty five (55) psi.

FIGS. 5A through E show the footprint of the bicycle tire 10 under the indicated loads of fifty (50); seventy five (75); one hundred (100); one hundred twenty five (125); and one hundred fifty (150) pounds of load, respectively, with the arch shaped cavity 14 at atmospheric pressure. FIGS. 6 and 7, A through E, show the foot print of a pneumatic tire that is of a like size and for supporting a like load to that of tire 10. Which pneumatic tire is pressurized to, respectively, to thirty five (35) and forty (40) psi. A comparison of the foot prints of the tire 10 with those of the pneumatic tire pressurized to thirty five (35) and forty (40) psi, respectively, shows that the tires have essentially the same foot print. This indicates that the bicycle tire 10, without air under pressure therein, will exhibit essentially the same support, stability and ride characteristics of the pressurized pneumatic tire.

FIG. 8 shows an automobile tire 40 embodiment of an air no air tire of the invention that is like the tire of FIGS. 1B and 2A through 2D, only therein the tire 40 is shown as having an arch shaped cavity with an arc of one hundred forty (140) degrees that is formed by lowering the point of origin, shown as F′, to below a horizontal line X′ that extends across lower end corners 45a and 45b of the tire outer surface, below the tread 44a, and curved inner sections 47a and 47b that fit against inner surfaces of hook ends 48a and 48b of rim 47. A vertical center line extends through a right angle junction with horizontal line X′ a selected distance to the point of origin F′ therebelow. Thereby, for a selected distance of point F′ below the crossing point of the center vertical line and horizontal line X′, a radius G′ swung from point F′ will have an arc of approximately one hundred forty (140) degrees as will a radius H′ that is also swung from point F′ that is an outer surface 43 of the tire 40, below the tread 44a. The tire 40 is preferably manufactured from an elastomeric material, preferably a urethane, by spin casting methods, but may be formed from a natural or synthetic rubber, or the like, by liquid or pressure molding methods, within the scope of this disclosure. In which preferred spin casting method of manufacture, a mold is formed to cast the tire 40 that is open between its lower or web ends 46a and 46b to fit in a rim 47. Shown in FIG. 8, the tire 40 side wall ends 46a and 46b, are located below the curved inner sections 47a and 47b and are to fit between outer support hook end sides 47a and 47b and vertical sides 48a and 48b of a rim web upstanding center platform 49.

The tire 40, like the tire 10, as described above, is formed with the arch shaped cavity 41, that, as shown in FIG. 8, includes a radius H′ that is swung from point F′ through, one hundred forty (140) degrees of arc, illustrating a lower range of acceptable arcs of the arch shaped cavity of the tire of the invention. The longer radius H′, is also swung through one hundred forty (140) degrees from the point F. So formed, the inner arch shape cavity 41 arc and the arc of the tire outer arch 43, below the tire tread 44a, are alike. So arranged, for both arch shaped cavities of tire 40 of FIGs. 1A, 1B and 8, like the tire 10, the distance between the inner cavity 42 and outer side walls and top area 43, under the tread, is the same, and is carefully selected, as shown in FIGS. 2A through 2E, for the anticipated load as the tire will carry. FIG. 1A, 1B and 8 thereby illustrate that the arc of the arch shaped cavity 41 of the tires 40 can be from one hundred forty (140) to one hundred eighty (180) degrees.

Like the bicycle tire 10, the arch shaped cavity 41 of tire 40 alone provides a load bearing structure that is essentially the equivalent of the support provided by a like pneumatic tire that is pressurized appropriately. In practice, the tire 40 has an effective load bearing character that is the equivalent of a pressurization of thirty five (35) to forty (40) psi of a tube type or tube-less pneumatic tire, and which effective pressurization can be increased by pressurizing the arch shaped cavity, as discussed above with respect to tire 10. The thickness of the tire 40 tread does not, in practice, effect the load bearing capabilities of the tires 10 or 40 and therefore may be any appropriate thickness to provide the desired road gripping, traction, wear and stability characteristics.

As set out above, the arch shaped cavity 41 is illustrated in FIGS. 1A 1B, and 8, as having arcs formed by swinging radius G and G′ from points F and F′, respectively, through a maximum of one hundred eighty (180) degrees of arch to a minimum of one hundred forty (140) degrees of arc, respectively. It should therefore be understood that an arc of between one hundred forty (140) to one hundred eighty (180) degrees will provide satisfactory load support. Accordingly, FIG. 8 shows the point F′ wherefrom the one hundred forty (140) degrees of arch are scribed, by the first radius G′, forming the arch shaped cavity 41, and by radius H′, forming the tire outer surface 43, below the tread 44. So arranged, the arch shaped cavity ends are approximately on line with the tops of the tire side wall slots 47a and 47b, that receive the rear surfaces of rim hook ends 45a and 45b, respectively, fitted therein. It should therefore be understood that the arch shaped cavity of the invention can be one formed through from approximately one hundred eighty (180) degrees to one hundred forty (140) degrees of arc and still provide a tire that, without air under pressure in the cavity, will support a design load for a specific wall thickness, as compared to a pneumatic tire constructed to support a like load that is of a similar size and design load capability that is aired to a tire pressurize of between thirty five (35) to forty (40) psi.

The tire 40 of FIG. 8, as set out above, is formed to resemble a conventional tube type or tubeless pneumatic tire to be mounted on rim 47. In which mounting the tire side wall ends are fitted into the rim 47, with the rim hook ends 45a and 45b face outwardly such that their back surfaces fit, respectively, into the tire side wall slots 47a and 47b. So arranged, the tire 40 side wall interior ends 46a and 46b are supported against the rim center platform 49 outer walls 48a and 48b. As needed, to add additional mounting support, as shown in FIG. 9, beads 61a and 61b that are preferably hoops that are formed of a material, such as steel, carbon fibers, or the like, can be included in tire 55, fitted around and within the ends of the side walls to provide locking of the tire side wall ends in the rim 65. While a tire like tire 40 has, in practice, been used successfully without beads for an automobile tire, it is preferred, to insure a secure tire mounting onto a rim, that beads are used. For some light vehicle application, such as for a motor scooter tire, however, beads may not be required. In practice, such a motor scooter tire without beads that incorporated the arch shaped cavity maintained at ambient pressure was found to safely support a load of seven hundred (700) pounds, and which tire was aired to a pressure of approximately six (6) pounds safely supported a load of one thousand (1000) pounds, illustrating the stability of the tire 40 of the invention.

As set out above, the tire 55 of FIG. 9 is like the tire 40 of FIGs. 1A, 1B and 8, in that it has the same design, is formed from an elastomeric material, preferably a urethane elastomer, but may be formed from natural or synthetic rubber, or the like, by spin casting or molding methods, producing a tire 55 that is open between its side wall ends and includes an arch shaped cavity 56. The arc of which cavity 56 is also formed to have from one hundred forty (140) to one hundred eighty (180) degrees of arc, as illustrated by a radius L that is turned from a point J that is the intersection of a horizontal line I laid across the tire, just above the tire side walls support contacts with rim 65 side walls 66 top ends, and vertical line K that vertically bisects the tire 55. The tire outer arch is illustrated as being turned also from point J by a longer radius L′. In practice, the inside and outside arcs must match, with the distance between the inner cavity arch and the outer arch being uniform across the distance or thickness between the cavity walls to the tire side walls 57a and 57b, and across the tire top portion 58, below the tread 59, and as set out and described in detail above, is selected for the tire anticipated load. The tire arch shaped cavity wall ends 60a and 60b terminate at their contacts with the rim 65 surfaces 68a and 68b, between inner and outer side wall ends 67a and 67b and 66a and 66b, respectively. The tire 55 side wall ends 60a and 60b, like the side wall ends of tire 40, are for fitting in, and are supported on the rim sides 68a and 68b, between rim 65 inner and outer walls, 66a and 66b and walls 67a and 67b, respectively.

A tire 55, as shown in FIG. 9, is mounted to rim, like rim 65 shown in FIGS. 9 and 10, as described above, and has, in practice, been produced as a high duty tire that is suitable for use on a light automobile. Like tires 10 and 40, tire 55 is preferably manufactured from urethane elastomer, natural or synthetic rubber, or the like, utilizing spin casting or liquid or pressure molding methods to have a wall thickness across the cavity arch, under the tire tread, selected to support a design load, as set out above with respect to the discussion of FIGS. 2A through 2E. So arranged, with the tire arch shaped cavity at atmospheric pressure, dependant upon the selected wall thickness the tire 55, like tires 10 and 40, tire 55 will support a design load, that can be further enhanced by the inclusion of beads 61a and 61b, shown in FIG. 9, with a reinforcement of a ply 62 or plys 62 and 63. Which ply or plys ends, as shown, preferably wrap around the beads 61a and 61b, and extend around the cavity arch, encapsulated between the arch shaped cavity wall and the tire outer wall. The ply or plys 62 and 63, as shown, function like separate belts and plys of a pneumatic tire, or a separate belt or belts can be fitted over the plys, under the tread, functioning as a belt or belts of a pneumatic tire. So arranged, the tire 55 with beads 61a and 61b and the continuous plys 62 or plys 62 and 63, are capable of supporting higher loads and/or are included for safety reasons. The plys 62 or plys 62 and 63 are preferably formed as flat meshes from fiber glass, carbon or graphite fibers, steel, or the like materials, and are installed in the tire 55 during the tire casting or molding process. At least one of which plys, and preferably both plys, as shown in FIG. 9., extend to the beads 61a and 61b, that are continuous hoops formed from a high tensile strength material and are installed at the end portions of the tire side walls. With the inclusion of beads 61a and 61b along with ply 62 or plys 62 and 63, the tire thickness between the arch shaped inner cavity wall and the tire outer surface, under the tread, can be reduced with the tire still exhibiting the design load support capabilities of the thicker walled tire, like the tire configurations of FIGS. 2A through 2G.

The tires 10, 40 and 55 to carry an appropriate design load are formed with the arch shaped cavity and to have a wall thickness as is appropriate to safely handle such design load. Further, preferably, each tire 10, 40 and 55, can include a valve stem, fitted thereto, as illustrated in FIG. 4B, or the like, for injecting air under pressure into the tire arch shaped cavity, for increasing the load carrying capability of the tire.

Preferred embodiments of the air no air elastomeric tire of the invention have been shown and described above. It will, however, be apparent to one knowledgeable or skilled in the art that the above described embodiments may incorporate changes and modifications without departing from the general scope of this invention. Which invention therefore is intended to include all such modifications and alterations in so far as they come within the scope of the appended claims and/or a reasonable equivalence thereof.

I claim

1. An elastomeric tire comprising, a tire casing formed by casting methods from an elastomeric material to have a continuous arch shaped interior cavity with the arc of said interior arch shaped cavity centered under a tire casing outer portion tread that has a same arc as the arc of said interior arch shaped cavity, and said interior arch shaped cavity and said tire casing outer portion, under the tread, have a like uniform arc of from one hundred forty (140) to one hundred eighty (180) degrees, with said tire casing having a uniform thickness across said arches that is selected for a particular anticipated load as said tire will support with said inner arch shaped cavity at atmospheric pressure; and including means for mounting end portions of side walls of said tire casing to a rim.

2. The elastomeric tire as recited in claim 1, wherein the tire casing side walls each include an identical mounting groove or slot that are each formed around a tire side wall lower or end portion, with each said groove or slot for fitting to an end portion or slot of a rim side wall, for mounting said tire casing onto said rim.

3. The elastomeric tire as recited in claim 1, wherein the tire casing is closed across the lower end portions of the tire casing side walls; and a valve stem is installed through the rim and into the arch shaped cavity to pass air under pressure therein.

4. The elastomeric tire as recited in claim 1, where the tire casing is open across the tire casing side walls, and the rim is provided with outer and inner upstanding side walls for receiving and supporting the lower end portions of said tire casing side walls; and the rim is fitted with a valve stem passed therethrough and into the arch shaped cavity for passing air under pressure therein.

5. The elastomeric tire as recited in claim 1, wherein the thickness of the material between the inner arch shaped cavity and casing outer portion arch, under the tread, is selected to support, when said inner arch shaped cavity is at atmospheric pressure, an anticipate design load, said thickness of material is less for a light load than a heavier load, and which said thickness of material increases proportionally with increases in anticipated load.

6. The elastomeric tire as recited in claim 5, further including a pair of like beads that are each fitted and cast within the lower portions of the casing side walls.

7. The elastomeric tire as recited in claim 6, further including at least a first ply formed from a mesh material and is installed in the tire forming process to encircle the tire top portion, below the tire tread and within the tire side walls, with ends of said ply extending to said tire side walls lower portions.

8. The elastomeric tire as recited in claim 7, wherein the mesh material is a mesh of fiber glass, a weave of graphite or carbon fibers, steel, or other appropriate material, formed into a flexible mesh material to extend around the tire casing.

9. The elastomeric tire as recite in claim 7, wherein the pair of like beads are each identical hoops formed from a material that is inelastic and has a high tensile strength, with each said hoop fitted in each of the lower portions of the tire side walls, and each said bead is in contact with an edge of the first ply secured thereto.

10. The elastomeric tire as recited in claim 9, further including a second ply formed of a like material like that of the first ply and installed in the tire forming process to pass over the tire top portion, extending into the tire side walls lower portions and engage the beads.

11. The elastomeric tire as recited in claim 10, wherein the ends of each of said first and second plys are fitted around each bead

12. The elastomeric tire as recited in claim 1, wherein the tire casing is formed from a elastomer by molding methods.

13. The elastomeric tire as recited in claim 12, wherein the tire casing is formed by spin casting methods.

14. The elastomeric tire as recited in claim 1, wherein the tire casing is formed form natural or synthetic rubber.

15. The elastomeric tire as recited in claim 14, wherein the tire casing is formed from an isosyanate and polyol as a chain extender that are combined together as sprays directed into a spin casting apparatus wherein the tire is formed.
